(19) United States
(12) Patent Application Publication
(10) Pub. No.: US 2022/0383665 A1
(43) Pub. Date: Dec. 1, 2022

(54) VEHICLE ACCIDENT DETECTION SYSTEM

(71) Applicants: Merrick Waterman, Mountlake Terrace, WA (US); Tennie Kay Burak, Mountlake Terrace, WA (US)

(72) Inventors: Merrick Waterman, Mountlake Terrace, WA (US); Tennie Kay Burak, Mountlake Terrace, WA (US)

(21) Appl. No.: 17/536,354

(22) Filed: Nov. 29, 2021

Related U.S. Application Data
(60) Provisional application No. 63/192,675, filed on May 25, 2021.

(51) Int. Cl. G07C 5/00; G07C 5/08; B60W 40/12

(52) U.S. Cl. CPC G07C 5/008; G07C 5/0816; B60W 40/12

(57) ABSTRACT

A vehicle event detection system is disclosed, including an event detection module in operable communication with a vehicle computing system. The event detection module is in operable communication with one or more vehicle and body framework sensors to detect an impact, one or more accelerometers, one or more gyroscopes, and an airbag deployment module. A control module receives an output signal from the event detection module if an event occurs, the control module to transmit an output signal to a marking device to deploy a marker at a location of the event.

### CROSS-REFERENCE TO RELATED APPLICATIONS

The present application claims priority to U.S. Provisional Application No. 63/192,675 filed May 25, 2021, titled “VEHICLE ACCIDENT DETECTION SYSTEM,” which is hereby incorporated by reference in its entirety.

### TECHNICAL FIELD

Embodiments of the invention relate to vehicle safety devices utilized at or substantially temporally near the time of an accident.

### BACKGROUND

Modern vehicles include various safety devices relating to accident event damage mitigation, including resilient construction, seatbelts, and airbags that help reduce the trauma experienced by the driver and passengers within the vehicle. However, analyzing the aftermath of an accident to determine causation can be difficult, including, in some instances, determining what or who is at fault. This task is often left to a police officer who arrives on scene, to insurance adjusters or analysts, and/or to the various parties and witnesses involved in the accident.

In the current arts, some vehicle owners and manufacturers equip their vehicles with cameras arranged to view their vehicle's surroundings. These cameras can be used as anti-theft or theft deterrent devices, or as a way or means to monitor the surrounding environment while the vehicle is at rest or in motion. Video streams and still images that may be captured by such cameras can be stored and are often used as evidence in the event of an accident. While helpful, current systems provide limited aid in the technical analysis of a crash and may suffer from other problems such as blurring, obscured views, and others.

Due to the deficiencies in currently employed camera monitoring technology, it is desirable to have new systems, devices, and methods that indicate physical interactions between a vehicle and its surroundings during particular events, such as accidents, that are operable to mark the physical orientation of objects with respect to each other contemporaneously with or immediately after the occurance of such events.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to and disclose vehicle event detection systems, methods, and marking devices for use therewith, including event detection modules in operable communication with vehicle computing systems. The event detection modules are in operable communication with one or more vehicle and body framework sensors, one or more accelerometers, one or more gyroscopes, and an airbag deployment module, some or all of which can help to detect an impact. A control module is operable to receive an output signal from the event detection module if an event occurs and the control module can transmit an output signal to a marking device to deploy a marker at an event location.

The embodiments herein provide systems and devices that mark a roadway, vehicle body, and/or tire(s) of the vehicle at the time of an accident or similar event. This marking allows for post-analysis of the event based on contemporaneous physical circumstances and can aid in the determination of who or what was at-fault during an accident, and can aid in determining the location, direction, and speed of the vehicles involved.

In one aspect, the one or more accelerometers and one or more gyroscopes determine or measure if a threshold value to reached and output signal is transmitted to the control module once the threshold value is met or surpassed.

In one aspect, the marking device includes a gas cartridge to deploy a gas that in turn propels a marker through a barrel.

In one aspect, the barrel of the marking device is arranged to propel the marker to mark the roadway and the tire of the vehicle.

In one aspect, the marking device includes an electric solenoid to permit a needle to puncture the gas cartridge at the time of the event.

In one aspect, the control module is in operable communication with a storage device to store event data.

In one aspect, the airbag deployment module determines or indicates if the vehicle's airbags have been deployed.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the event detection module components in operable communication with the vehicle via the vehicle's computing system, according to some embodiments;

FIG. 2 illustrates a block diagram of the event detection system, according to some embodiments;

FIG. 3 illustrates a cross-sectional view of the marking device, according to some embodiments;

FIG. 4 illustrates a perspective view of the marking device, according to some embodiments; and

FIG. 5 illustrates a flowchart of event detection and marking, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a vehicle event detection system comprising at least one event detection module to detect an accident or similar event while using a vehicle. The event detection module is in operable communication with a plurality of sensors which detects the occurance of an event based on rapid condition changes and deploys at least one marker which may include liquid, solid, and/or gaseous material in the form of paint, chalk, powder, or similar means for marking the roadway, vehicle body, and/or vehicle tires at or about the time of the event.

As used herein, the term “event” is utilized to indicate an accident, impact, collision, rollover, theft attempt, or other event which may cause damage to the vehicle and/or injury to passengers or pedestrians.

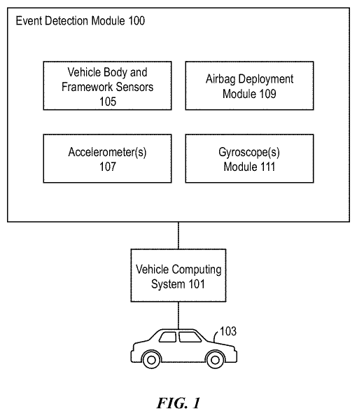

FIG. 1 illustrates a block diagram of an event detection module 100 in operable communication with a vehicle's computing system 101. In various embodiments, event detection module can include one or more processors, non-transitory computer readable memory, power components, networking components, inputs and outputs, operating systems, and/or others as needed and as known in the art and configured to be operable and achieve the objectives described herein.

The event detection module 100 can be in communication or otherwise operably communicatively coupled with one or a plurality of sensors positioned on, in, and/or around the vehicle 103. In various embodiments the sensors may include vehicle body and/or framework sensor(s) 105, one or more accelerometers 107, one or more airbag deployment modules 109, and/or one or more gyroscopes 111. Other sensor modules are also contemplated in various embodiments, including heat sensors, fluid sensors, humidity sensors, light spectrum sensors, auditory sensors, chemical sensors, pressure sensors, airflow and/or windspeed sensors, electrical sensors, and others. In some embodiments, the vehicle body and framework sensors 105 can be securely adhered to the body and/or framework of the vehicle 103 to prevent false positives that may indicate the occurance of an event when none has taken place in reality. The accelerometer(s) 107 and gyroscope(s) 111 can be operable to detect sensed values (i.e. operating conditions) and may be triggered if the sensed value meets or exceeds a threshold value which is indicative of a crash event. This threshold value may be stored in non-transitory computer readable memory and the detection of sensed values and comparison to threshold value(s) can be performed by one or more special purpose processors or general processors that are specially programmed to perform such operations. If and when a particular threshold value is met or exceeded, an output signal can be transmitted by the sensor or its associated monitoring processor to the event detection module 100. Thereafter, the event detection module can trigger the marking device to mark the tires, vehicle body, and/or roadway at or substantially near the location of the event.

The airbag deployment module 109 may be in communication with the vehicle's computing system 101 to determine if the airbags have been deployed. Upon deployment of one or more airbags, an output signal can be transmitted by a processor of the airbag deployment module to the event detection module 100, which can trigger the marker to mark the tires, vehicle body, and/or roadway at or substantially near the location of the event.

In some embodiments, the vehicle body and framework sensors 105 can be configured as impact sensors to detect and impact to the vehicle's body and/or framework. The vehicle body and framework sensors 105 can operate using various techniques discussed herein. In some example embodiments, the vehicle body and framework sensors 105 are configured as electro-mechanism impact sensors which utilize a free-moving metallic body and magnetic components to bridge and break a circuit. While under normal conditions the circuit is complete, once the circuit is broken an output signal is transmitted to the event detection module 100 to trigger the marking device. This can cause the marking device to mark the tires, vehicle body, and/or roadway at or substantially near the location of the event.

In various embodiments these vehicle body and framework sensors 105 can be permanently or removably coupled to, attached to, or otherwise connected to or mounted on the vehicle. The placement, orientation, configuration, and number of sensors can vary from embodiment to embodiment and may be different based on the type of vehicle, desired operation, expected operating conditions, specific purpose (e.g. crash test car versus commuter vehicle versus race car), or others. In some embodiments, sensors 105 can communicate with each other via wired and/or wireless methods and components.

In some embodiments, the vehicle body and framework sensors 105 may be configured as or otherwise include electro-mechanical crush sensors placed at strategic locations in or on the vehicle 103. The electromechanical crush sensors may comprise a conductive element, a non-conductive (or insulating) separator, and a conductive spike. If and when the sensor is crushed (e.g during an event), the conductive spike will penetrate the non-conductive (or insulating) separator and contact the conductive element. This will ultimately complete the electrical circuit and trigger an output signal to the event detection module 100 to trigger the marking device to mark the tires, vehicle body, and/or roadway at or substantially near the location of the event.

In some embodiments, the vehicle body and framework sensors 105 may be configured as a plurality of or multiple layers of conductive tape (e.g., copper foil or other conductive material) which may be bonded with non-conductive dielectric layers (e.g, Kapton tape or other non-conductive or insulating layers) to form a capacitor of a particular or arbitrary length and/or shape. By using one or more sensors to continually monitor this setup for changes in capacitance, it is possible for the sensor to detect physical deformation in the capacitor due to the nature of the electrical characteristics monitored and measured. This information can in turn be used to output a signal to the event detection module 100 to trigger the marking device to mark the tires, vehicle body, and/or roadway at or substantially near the location of the event.

In some embodiments, the vehicle body and framework sensors 105 may be configured as fiber optic cables which can be measured for deformation or breakage using one or more sensors. Measurement of the fiber optic cables can be made by measuring the attenuation of light intensity or light interruption in at least one ring configuration with separate transmitters and receivers, or by reflecting light off of the far end of the fiber using a unified transmitter and receiver. If and when the light intensity or light interruption meets or exceeds (or falls below) a particular threshold, a signal can be outputted to the event detection module 100 to trigger the marking device to mark the tires, vehicle body, and/or roadway at or substantially near the location of the event.

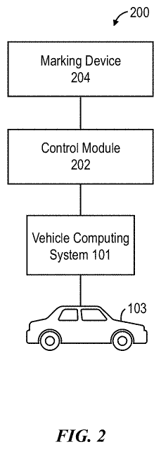

FIG. 2 illustrates a block diagram of the vehicle event detection system 200 including a control module 202 in operable communication with the vehicle computing system 101 of the vehicle 103. The control module 202 may allow for the selective and/or automatic operation of the event detection system described herein or may determine when the vehicle is operational (on and/or in motion). In various embodiments, the control module 202 is in electrical communication or otherwise electrically coupled with and powered by one or more onboard batteries of the vehicle 103 and may also be coupled to or include an auxiliary power supply. If and when an event is detected by the event detection module, an output signal is transmitted to the marking device 204 which deploys a marker to the roadway, vehicle body, vehicle components, surroundings, and/or tires of the vehicle. The control module 202 may communicate with the vehicle's computing system 101 to determine if the vehicle 103 is turned on and/or in motion. Detection that the vehicle 103 has been turned off and/or is not in motion may cause the control module 202 to deactivate the event detection system 200. However, in some embodiments event detection system 200 can be run on backup or auxiliary power, in order to detect events that have the potential to or are likely to occur even if the vehicle is not moving or is off. In some embodiments, the control module 202 may store data in a non-transitory computer readable memory. The data may be received from the event detection module and associated sensors, and/or from the vehicle's computing system 101. The memory can be removable, such as a flash drive, or may be accessible via a wired or wireless connection in some embodiments. In such embodiments, ty pical networking and/or data communication plugs and receivers can be employed (e.g. wireless transceivers, USB plugs/receivers or others). Further, the control module 202 may include a self-training module to determine proper threshold values for each sensor. In such embodiments, feedback loops can be employed by the sensors and a processor to train the system with typical operating conditions and even atypical conditions such as rapid acceleration and deceleration which may occur, but which do not qualify as the type of event that may trigger the marking device(s).

In some embodiments, the control module 202 may log data in non-transitory computer readable memory including vehicle diagnostics, vehicle location (via a communicatively coupled or onboard GPS system), event data (speed and direction which the vehicle was traveling at the time of the event and/or leading up to the event), and data received from each sensor.

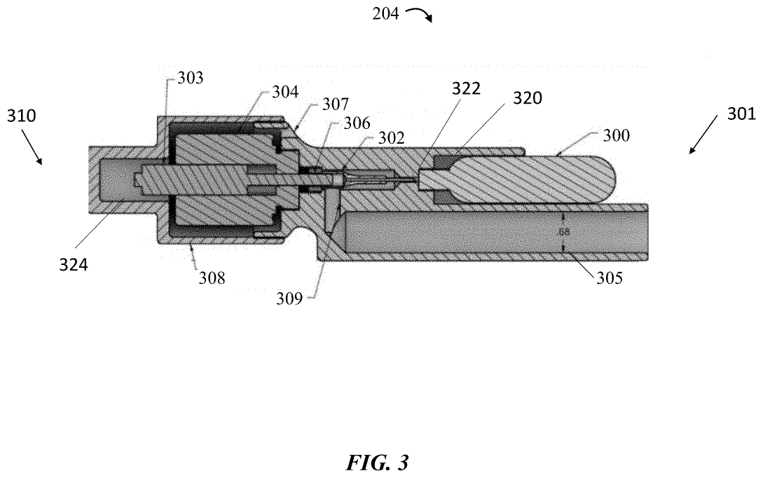

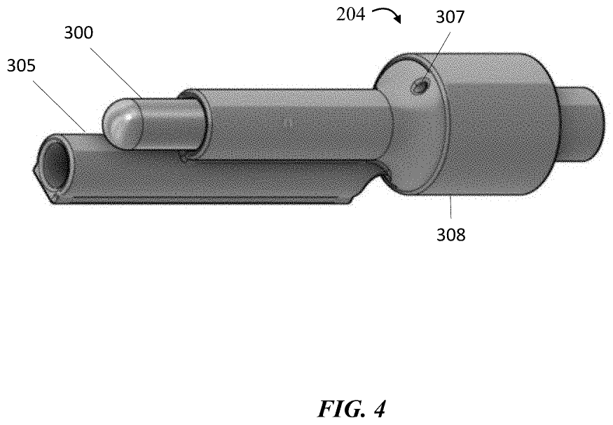

FIG. 3 and FIG. 4 illustrate the marking device 204 positioned on the vehicle to deploy a marker at the time of an event. Specifically, FIG. 3 illustrates a cross-sectional view to show the internal components of the marking device 204, and will be described with respect to a distal end 301, and a proximal end 310.

The marking device 204 can include a gas cartridge 300 (e.g., carbon dioxide (CO₂), or other pressurized gas) which may be a specialized container or canister for marking device applications or may be a standardized size with standardized characteristics in various embodiments. As shown, the gas cartridge 300 can include a distal rounded end and a proximal insertion end with a head that is cylindrical and that can include an exterior threaded screw mechanism (not specifically shown). The gas cartridge 300 can initially be inserted proximally into a cartridge holding chamber 320, whereby the threaded cylindrical end of gas cartridge 300 mates with an appropriately sized proximal receiver end 322 of cartridge holding chamber 320 and is held in a fixed position within cartridge holding chamber 320. Other holding and/or fixation mechanisms are also contemplated, including clamps, adhesives, magnets, gaskets, and others.

In operation, a proximal end of gas cartridge 300 can include a seal, such as a layer of plastic, rubber, metal, or other material that is adhered to or arranged such that an opening in the center of the proximal cylindrical end of the gas cartridge 300 may be opened with the seal is pierced by a needle 302. Needle 302 can be pushed or otherwise actuated from a first standby position to a second piercing position by an electric solenoid plunger 303 housed within a solenoid body 304. The sealed gas cartridge 300 can be the primary source of stored energy as it can be suitable for long-term deployment. In many embodiments, the use of carbon dioxide or nitrogen gas is preferred, since the gas cartridges 300 are readily available in the marketplace and the gasses are themselves inert. Other gasses can be substituted in various embodiments without significant change to the design. Once the seal on the gas cartridge 300 has been pierced of otherwise broken, the escaping gasses are used to propel one or more paintballs (or other marking element such as chalk) from an integrated barrel 305.

The solenoid body 304 include a cap 308 that can retain the electric solenoid plunger 303 therein. Cap 308 can include a hollow opening 324 that allows solenoid plunger 303 to be housed therein in a standby or ready position before it is deployed or actuated along an axis it shares with needle 302, which it is coupled with, and gas cartridge 300. A retaining nut 306 can be permanently installed or otherwise affixed in a location proximal to gas tap port 309 and provided to retain the needle 302 that it is circumferentially oriented around in a needle deployment channel during operation of the marking device 204. A wire port 307 can be a hole or passthrough that extends between an exterior of marking device 204 and a hollow interior of cap 308 that permits the input of wiring to operate the marking device 204. This wiring (not shown) can be coupled to one or both of solenoid body 304 and solenoid plunger 303, and/or a controller and/or processor that operable controls the functioning of marking device 204. The gas tap port 309 permits and/or restricts the flow of gas from the gas cartridge 300 to the barrel 305.

In operation, when the gas cartridge 300 has its seal pierced, the gas exits about or around the needle into the needle deployment channel and through the gas tap port 309 where it may meet a proximal end of a projectile such as a paintball or other cartridge housed in barrel 305, whereby the pressure of the gas ejects the projectile out of an open distal end of the barrel (or chamber) 305.

In some embodiments, a pre-loaded spring is provided between the retaining nut 306 and the needle 302. The pre-loaded spring reduces the total amount of force that the solenoid needs to apply to pierce the cartridge 300 as compared to embodiments without the inclusion of a pre-loaded spring. The pre-loaded spring can be oriented circumferentially about the same axis as needle 302, such that its proximal end abuts a distal end of retaining nut 306 and its distal end abuts a proximal end of needle 302. In some embodiments these components can be removably or permanently coupled with each other in the described orientation or in other orientations, while in other embodiments they may just rest alongside one another in appropriately sized housing locations within marking device 204.

In some embodiments, the marking device 204 may include the use of and/or integration with an external pneumatic source and/or the gas produced by an electrically-ignited, deflagrating material such as smokeless gunpowder to cause ejection of the projectile from the barrel 305. Barrel 305 can be cylindrical and may include rifling in some embodiments, in order to provide improved accuracy, as is known in the projectile launching arts.

In some embodiments, the escaping gas may also be used to power other mechanical functions of the marking device 204, such as releasing a dust-cover on or otherwise covering the otherwise open distal end of barrel 305. Those skilled in the art will understand that such dust-cover can protect the interior of barrel 305 and any projectile(s) housed therein from contamination and/or obstructions that may cause misfiring or other issues that hinder the desired and normal operation.

As shown in the example embodiment depicted in FIGS. 3 and 4, a central axis of barrel 305, can be generally parallel with a central axis of gas cartridge 300, while gas tap port 309 can be generally perpendicular to such axes and disposed between them. In other embodiments, different orientations are possible and may be preferable, to provide improved gasflow characteristics or other benefits.

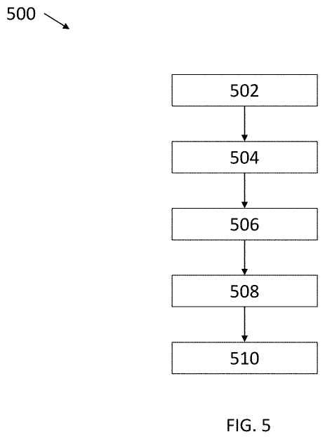

FIG. 5 illustrates a flowchart 500 of event detection and marking, according to some embodiments. As shown in the example embodiment, a first step 502 can include at least one vehicle body sensor, accelerometer, gyroscope, and/or airbag sensor measuring a value that meets or exceeds a threshold. Once the threshold value has been met or exceeded, the sensor may trigger an output signal and/or an event detection module may otherwise determine that an event is occurring or has occurred in step 504. The event detection module can then send a triggering command signal to the marking device in step 506. In step 508 and upon receiving the triggering command, the marking device can cause actuation of an electric solenoid, which causes a needle to pierce a gas cartridge. The gas cartridge can then emit gas at a sufficient rate and volume to eject a marker from a barrel of the marking device in step 510, which marks an event scene, including a tire, vehicle component, and/or roadway.

It should be understood that marking device 204 can be mounted in any number of different locations and/or orientations in order to achieve the desired benefits described herein. Mounting can be performed automatically by machine, semi-automatically by machine with human assistance/guidance, or manually by a human. Mounting can be accomplished by many different means or combinations of means, including soldering, welding, or affixing with glue, resin, epoxy, or other adhesive, by using secondary mounting mechanisms such as brackets and screws or the like, or others. Mounting may be performed by automobile or vehicle manufacturers, vendors, third-parties, end consumers, or other parties.

In some embodiments, the vehicle event detection system includes a plurality of auxiliary electrical inputs and or receivers to enable the integration of auxiliary devices as well as future implementations of the vehicle event detection system. Those in the art will understand that primary or aftermarket controllers, including processors and memory as well as power and networking functionality can be used to manage inputs and effectively operate such systems.

In some embodiments, sensors associated with an individual vehicle can be remotely coupled with and/or communicate with systems that are associated with other vehicles. As such, detection of an event with respect to one or more vehicles can trigger devices from nearby vehicles to also actuate and mark their locations at the time of the event. This can lead to better scene reconstruction for event investigators in the future, who may be tasked with determining fault and/or reconstructing accident scenes. This type of remote communicate can also set off particular colors in some embodiments, which may indicate that a particular nearby vehicle is a secondary vehicle, not involved in a primary event. As such, vehicles networked together can operate to create smart transportation systems. Those in the art will understand that networking components may be required in such embodiments, and can use existing protocols such as Bluetooth, Wi-Fi, 5G, or many others, existing or later developed, in order to accomplish such objectives.

On a similar and related note, smart car and/or smartphone integration can be implemented in various embodiments. With the rise in smart devices and electric vehicles, it is contemplated that users may have even greater control over the features and uses of the systems, devices, and methods described herein. Manually marking a parking location using these systems, devices, and methods could allow users to prove innocence in parking ticket situations, or the like. In some embodiments, gas cartridges and/or projectiles may be reloadable, for multiple uses. Multi-barreled setups can be implemented in order to accomplish different objectives. Different projectiles may allow for different event scenarios to be dealt with in different manners. For instance, to deter criminals a slippery substance, flame, or noxious gas may be emitted from the devices. If vermin, bugs, or other pests are prevalent in an area and prone to interfere with vehicles, deterrents can be implemented based on pre-programmed and/or learned event conditions that the vehicle may sense using manufacturer or third-party installed equipment such as cameras, heat, or other sensors.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A vehicle event detection system, comprising:
an event detection module in operable communication with a vehicle computing system, the event detection module in operable communication with at least one vehicle framework sensor to detect an impact, at least one accelerometer, at least one gyroscope, and an airbag deployment module; and
a control module to receive an output signal from the event detection module,
wherein, if an event occurs, the control module transmits an output signal to a marking device to deploy a marker at a location of the event.

2. The system of claim 1, wherein a controller coupled to the at least one accelerometer and at least one gyroscope determine if a threshold value is reached, and wherein the output signal is transmitted to the control module when the threshold value is reached.

3. The system of claim 1, wherein the marking device includes a gas cartridge to deploy a gas that propels the marker through a barrel of the marking device.

4. The system of claim 3, wherein the barrel is oriented to propel the marker to mark the roadway and a tire of the vehicle.

5. The system of claim 4, wherein the marking device includes an electric solenoid that, when actuated, causes a needle to puncture the gas cartridge at the time of the event.

6. The system of claim 5, wherein the electric solenoid comprises:
a cap; and
a plunger.

7. The system of claim 6, wherein the plunger is coupled to the needle.

8. The system of claim 1, wherein the control module is in operable communication with a computer readable memory to store event data.

9. The system of claim 1, wherein the airbag deployment module determines if the vehicle's airbags have been deployed.

10. The system of claim 1, wherein the marking device comprises a gas tap port.

11. A device mounted to a vehicle for marking the scene of a vehicle accident, comprising:
a gas cartridge;
an actuator mechanism; and
a barrel for directing a projectile in a specific direction to mark the scene.

12. The device of claim 11, wherein the actuator mechanism comprises:
a solenoid.

13. The device of claim 11, further comprising:
a needle.

14. The device of claim 13, wherein the needle is coupled to the actuator mechanism.

15. The device of claim 14, wherein the needle pierces a seal of the gas cartridge to release gas contained therein upon the detection of an event.

16. The device of claim 15, wherein the gas passes through a gas tap port and causes ejection of the projectile from the barrel.

17. The device of claim 11, further comprising:
a wire port.

18. The device of claim 11, wherein the device is mounted with at least one weld.

19. The device of claim 11, wherein the device marks the scene using a paintball.

20. The device of claim 11, wherein the device marks the scene by marking a roadway and a tire of the vehicle.
